(19) United States
(12) Patent Application Publication
(10) Pub. No.: US 2015/0076122 A1
(43) Pub. Date: Mar. 19, 2015

(54) ARRANGEMENT FOR THE OPERATION OF A WELDING SYSTEM

(71) Applicant: Robert Bosch GmbH, Stuttgart (DE)

(72) Inventor: Werner Meister, Reichelsheim (DE)

(21) Appl. No.: 14/484,426

(22) Filed: Sep. 12, 2014

(30) Foreign Application Priority Data
Sep. 13, 2013 (DE) 10 2013 218 357.7
Jan. 10, 2014 (DE) 10 2014 200 266.4

(51) Int. Cl. B23K 11/24; B23K 11/25

(52) U.S. Cl. CPC B23K 11/241; B23K 11/255; B23K 11/257; B23K 11/258
USPC 219/116; 219/108

(57) ABSTRACT

A welding system includes a first field bus. The welding system further includes a first welding converter, wherein the first welding converter is operatively connected to the first field bus via a first interface. The welding system further includes at least one further component, wherein the at least one further component is operatively connected to the first field bus. The first welding converter is configured to transmit an actuation data to the at least one further component using the first field bus to actuate the at least one further component.

This application claims priority under 35 U.S.C. §119 to patent application nos. DE 10 2013 218 357.7 filed on Sep. 13, 2013 in Germany and DE 10 2014 200 266.4 filed on Jan. 10, 2014, the disclosures of which are incorporated herein by reference in their entirety.

The present disclosure relates to an arrangement for the operation of a welding system.

### BACKGROUND

Welding systems, particularly resistance welding systems, are used in automated bodyshell production, for example.

EP 1 512 483 A1 discloses a resistance welding system in which necessary components such as welding converter, power supply, servo pliers control and welding process control form a physical unit. This requires a resistance welding system of this kind to be stipulated for a particular output power or a particular range for an output power, particularly in respect of a welding converter. If a different output power is needed for a different application, a different welding system is required that is designed for the different output power. A combination of components of the resistance welding system is also stipulated thereby and can be altered only awkwardly.

EP 2 353 766 A2 discloses a service device for a welding device, wherein the welding device is designed for a particular output power or a particular range for an output power.

In order to achieve higher output powers, it is possible to combine a plurality of welding converters, but the prior art requires special welding converters for this and the necessary analog cabling is complex and susceptible to interference.

It is therefore desirable to specify a way of combining a plurality of welding converters and/or other components of a welding system such that a resultant output power and/or a process environment can easily be adjusted to suit various requirements.

### SUMMARY

The disclosure proposes an arrangement for the operation of a welding system as disclosed herein. Advantageous refinements are subject matter of the subclaims and also the description that follows.

The disclosure is suited to the operation of a welding system, particularly a resistance welding system. By connecting the individual components, particularly welding converters, by means of a field bus, it is possible to control the welding system in real time. Furthermore, it is possible for the components to be cabled in a simple manner.

In this case, a welding converter essentially comprises a control unit (control part) and a power unit (power part). The power unit evaluates connected sensors for physical variables (welding current, secondary voltage, electrode force, welding transformer temperature, power output stage temperature, etc.) and monitors the latter for admissible limit values. At the same time, it produces appropriate manipulated variables for an included power output stage and possibly calculates process quality characteristics. The control unit controls the power unit by prescribing appropriate setpoint values for the regulators. An installation bus interface, particularly likewise a field bus, incorporates the control unit into a network of a superordinate process landscape (e.g. robot cell). The control unit uses dedicated interfaces, preferably likewise a field bus, to control any further peripheral units in the process environment (servo pliers drives, electrode cap milling cutters, I/O stations, etc.). With further preference, the control unit performs process data filing, such as storage and selection of welding programs for prescribing and controlling the power unit, monitoring, logging and archiving of the welding process actual values and quality characteristics from the power unit.

A field bus is a communication system for controllers and/or other components, for example, with actuation data, acknowledgements and/or measured values being transmitted digitally, for example. In this case, the transmission takes place in a coded form. In comparison with analog transmission, this ensures a higher level of interference immunity. In addition, a system with a field bus is capable of self-diagnosis. Particularly suitable field buses are field buses with real time capability and/or based on EtherNet, such as SERCOS III, Profinet, EtherNet/IP etc. These are very robust and are based on tried and tested network technology. “Real time capability” is understood to mean that the operation (e.g. current generation, movement, etc.) of the connected units, such as converters, welding pliers, cap milling cutters, etc., takes place in a defined temporal relationship with one another. This allows particularly the synchronous operation of welding converters for increasing power.

Preferably, further components for the welding system, such as servo pliers or pliers changers, are also easily linked to the field bus and actuated in real time. In this case, no further additional connecting components, such as a card rack or a backplane or the like, are needed. The components can be positioned with relative freedom or in a manner adjusted to suit the requirements.

Advantageously, the arrangement comprises more than one welding converter, with the welding converters being controlled simultaneously via the field bus. In the case of appropriate secondary-side interconnection, it is thus possible for the output powers from the identical welding converters to be added, and the welding system can be adjusted, in cascaded fashion, to suit various requirements. Specific adjustments to the individual welding converters are not necessary in this case.

It is advantageous if the welding converters are connected to a further, separate field bus. The further field bus is, in particular, of the same type as the first, but the welding converters each use an additional interface that is provided only for a master/slave mode of the welding converters among one another. As a result, the performance of the first field bus for controlling the other components is not adversely affected.

A further advantage is obtained when, in the case of connection of an operator control unit by the welding converter or of the control unit thereof to the operator control unit, necessary parameters of the welding system are transmitted to said operator control unit. Specific adjustment of a piece of software for the operator control unit to suit various configurations of the welding system is therefore not necessary.

Expediently, the complete parameter definitions of a welding controller are filed in a “parameter description file”, for example in XML format, in the welding converter or the control unit. This file is used to store parameters, the properties and group associations thereof according to defined rules. Each parameter of a welding controller is described therein. The parameter description file is part of the controller. When setting up a connection to a user interface (PC software), the file is transmitted to the operator control computer. The user interface on the operator control computer thus automatically knows the current state of the entire parameter structure of the welding controller that it is intended to be used to control. The parameters of the welding controller are therefore easily modifiable and extendable without the need for these changes to be entered into a piece of operator control software in complex fashion.

An inventive operator control unit, e.g. a computer, is set up, particularly in terms of programming, to control an inventive arrangement.

Further advantages and refinements of the disclosure arise from the description and the accompanying drawing.

It is self-evident that the features cited above and those yet to be explained below can be used not only in the respectively indicated combination but also in other combinations or on their own without departing from the scope of the present disclosure.

The disclosure is shown schematically in the drawing with the aid of exemplary embodiments and is described in detail below with reference to the drawing.

### BRIEF DESCRIPTION OF THE DRAWINGS

The disclosure is shown schematically in the drawing with the aid of exemplary embodiments and is described in detail below with reference to the drawing.

FIG. 1 schematically shows an arrangement for a welding system in a preferred refinement with one field bus.

FIG. 2 schematically shows an arrangement for a welding system in a preferred refinement with two field buses.

### DETAILED DESCRIPTION

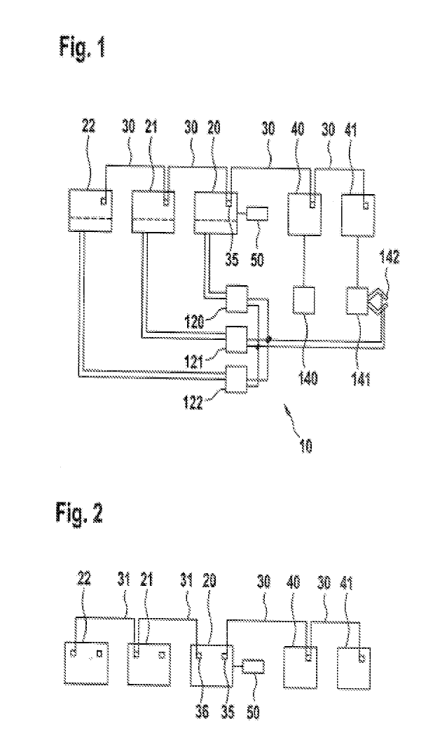

FIG. 1 schematically shows a portion of a welding system 10. In a preferred refinement, the welding system is a resistance welding system. In this case, the arrangement comprises a first welding converter 20 that is linked via a first interface 35 to a first field bus 30, for example a SERCOS III, that is used to control the welding system 10.

In addition, two further components 40, 41 of the welding system 10 are shown by way of example, said components being in the form of controllers 40, 41 for a handling device 140 and servo pliers 141 in this case. The controllers 40, 41 are also connected to the first field bus 30. In this case, further components 40, 41 may also be further and/or other components that are necessary for the process environment, such as controllers for electric drives or a pliers changer, a cap milling cutter, hand-held pliers with an extended I/O array or the like. The precise number and type of the further components is geared to the respective requirements. The controllers 40, 41 are actuated via the first field bus 30.

By way of example, two further welding converters 21, 22 are shown that are likewise linked to the first field bus 30. In a preferred refinement, the welding converters are operated in a master/slave mode. By way of example, the first welding converter 20 is operated as a master and the two further welding converters 21, 22 are operated as slaves. All the welding converters linked to the first field bus 30 can be actuated simultaneously, and in this case the actuation is coordinated by the master.

By way of example, one of the further welding converters 21, 22 can also act as a master, since the welding converters 20, 21, 22 are of the same design. A master controls the complete master/slave combination. Communication with other components 40 of the welding system (apart from the further welding converters) or with a superordinate system is carried out exclusively by the master, as if just the welding converter acting as a master but not the slave welding converters were existent.

In this case, essentially only the power unit is used for a welding converter in slave mode, and values, for example, are prescribed by means of the control unit of the master via the field bus. In the case of the welding converters 20, 21, 22 shown, a division into control unit (top) and power unit (bottom) is indicated by a dashed line.

The power units of the welding converters 20, 21, 22 are connected to at least one respective welding transformer 120, 121, 122, the secondary sides of which are in turn connected to an electrode pair 142 on the servo pliers 141, via which the current for the welding process is routed. The interconnection is in parallel on the secondary side, so that the currents from the individual welding transformers through the electrode pair 142 are added, thus obtaining an increased welding power.

The number of welding converters (and hence of subsequent welding transformers) can be adjusted depending on requirements, i.e. necessary welding power. The control is always effected via the first field bus 30, which means that the welding converters can be controlled in sync, thus allowing the addition of the powers from the individual welding converters to be ensured. The physical placement of the welding converters can be adjusted to suit the circumstances.

The arrangement shown for the controllers 40, 41 with the first welding converter 20 together with the further welding converters 21, 22 is merely exemplary. The necessary number of further components and/or further welding converters can be adjusted according to the respective requirements.

Measured values and/or status information from the welding system 10 are transmitted via the field bus 30. Furthermore, there is a possibility of diagnosis in the welding system 10. That is to say that errors that occur can be detected, in particular associated with the respective controller or the respective welding converter, and also rectified, for example. In a preferred refinement, the diagnosis is coordinated via the first welding converter 20.

Operator control of the welding system 10 is carried out using an operator control unit 50, for example, which may be a computer with appropriate software having a user interface, for example. In this case, the operator control unit 50 is connected to the first welding converter 20 by way of example. However, the operator control unit 50 may also be linked to a superordinate system (not shown), for example, to which the first welding converter 20 is linked.

Parameters that describe the individual welding converters/controllers 20, 21, 22, 40, 41 or the properties thereof are stored, for example in XML format, in a parameter description file, for example. When a connection to the operator control unit 50 is now set up, the parameter description file can be transmitted to the operator control unit. Hence, the operator control unit, particularly the operator control software, for example, does not need to be adjusted to suit different configurations of the welding system.

FIG. 2 schematically shows a portion of the welding system 10 in a similar manner to that in FIG. 1. In this case, the arrangement here comprises a first welding converter 20 that is linked to the first field bus 30, for example a SERCOS III, via a first interface 35 and is linked to a further field bus 31, for example also a SERCOS III, via a further interface 36.

The further welding converters 21, 22 are linked to the further field bus 31, this further field bus 31 being used specifically for the aforementioned master/slave mode of the welding converters 20, 21, 22. As a result, the performance of the first field bus 30, to which the further components 40, 41 are linked, is not restricted.

The further welding converters 21, 22, like the first welding converter 20, have a first and a further interface. The reason for this is that the welding converters, as also mentioned above, are of the same design and each one can act as a master. In the case of the further welding converters 21, 22, the first interface is then not used in slave mode, and the link to the further field bus 31 is made via the further interface in each case.

Otherwise, the arrangement in FIG. 2 is like that in FIG. 1. Welding transformers, handling device, servo pliers and electrodes are not shown, but may be incorporated in the welding controller 10 in the same way as in the case of the embodiment shown in FIG. 1.

What is claimed is:

1. A welding system comprising:
a first field bus;
a first welding converter, wherein the first welding converter is operatively connected to the first field bus via a first interface; and
at least one component, wherein the at least one component is operatively connected to the first field bus and the first welding converter is configured to transmit an actuation data to the at least one component to actuate the at least one component via the first field bus.

2. The welding system according to claim 1, wherein the at least one component includes a second welding converter;
wherein the first welding converter is configured to actuate the second welding converter via the first field bus by syncing the actuation data with the first welding converter.

3. The welding system according to claim 1, further comprising:
a second field bus, wherein the first welding converter is operatively connected to the second field bus via a second interface; and
a second welding converter, wherein the second welding converter is operatively connected to the second field bus and the first welding converter is configured to transmit the actuation data to the second welding converter via the second field bus to actuate the second welding converter in sync with the first welding converter.

4. The welding system according to claim 2, further comprising:
a first welding transformer; and
a second welding transformer,
wherein the first welding converter supplies power to the first associated welding transformer and the second welding converter supplies power to the second associated welding transformer; and
wherein outputs of the first welding transformer and the second welding transformer are connected in parallel to supply a summed output power from the first welding converter and the second welding converter.

5. The welding system according claim 1, wherein the at least one component comprises at least one of a control device for at least one of an electric drive, a handling device or an electrode cap milling cutter, and an input/output station.

6. The welding system according to claim 1, further comprising:
a second field bus, wherein at least one of the first field bus and the second field bus is configured to transmit at least one of status information and measured values.

7. The welding system according to claim 1, wherein the welding system is configured to diagnose the welding system.

8. The welding system according to claim 1, further comprising:
an operator control unit,
wherein parameters are transmitted from the first welding converter to the operator control unit in response to the operator control unit being connected to the first welding converter, wherein the parameters define an operation of the first welding converter.

9. The welding system according to claim 1, wherein at least one of the first field bus and the second field bus are a SERCOS III field bus.

10. The welding system according to claim 1, wherein the welding system is a resistance welding system.

11. The welding system according to claim 5, wherein the electric drive is servo pliers.
